(19) United States
(12) Patent Application Publication
(10) Pub. No.: US 2024/0015443 A1
(43) Pub. Date: Jan. 11, 2024

(54) LOUDSPEAKER

(71) Applicant: GRAWE & SCHNEIDER GDBR, Kiefersfelden (DE)

(72) Inventors: Thomas GRAWE, Kiefersfelden (DE); Gerd-Peter SCHNEIDER, Landshut (DE); Christian SEEBAUER, Nittenau (DE)

(73) Assignee: GRAWE & SCHNEIDER GDBR, Kiefersfelden (DE)

(21) Appl. No.: 18/267,146

(22) PCT Filed: Dec. 14, 2021
(86) PCT No.: PCT/EP2021/085765

§ 371 Date: Jun. 14, 2023

(30) Foreign Application Priority Data
Dec. 14, 2020 (DE) 20 2020 107 241.2

(51) Int. Cl. H04R 7/12; H04R 9/06; H04R 7/20; H04R 9/04

(52) U.S. Cl. CPC H04R 7/12; H04R 9/063; H04R 7/20; H04R 9/043; H04R 2499/13; H04R 2400/11

(57) ABSTRACT

The invention relates to a loudspeaker, preferably a planar loudspeaker, comprising a tone panel (10), a holder (12), at least one drive unit (14), preferably fastened to the holder (12), for driving the tone panel (10), the drive unit (14) having a coil body (20) with a coil, and having a magnet device (16), the tone panel (10) having a curvature and/or arching and an end face of the coil body (20) fixed to the tone panel (10) being adapted to the shape of the curvature and/or arching.

The invention relates to a loudspeaker, preferably a planar loudspeaker, comprising a sound panel and a drive unit for driving the sound panel.

DE 1O 2015 103 339 A1 discloses a planar loudspeaker. With regard to a possible design and/or mode of operation of a planar loudspeaker, in particular the drive unit, DE 10 2015 103 339 A1 is included and/or referred to—also with regard to the practicability and/or complete disclosure.

A loudspeaker is known from DE 10 2018 124 253 A1, which can have a stabilising device and/or centring device. With regard to a possible design and/or mode of operation of this loudspeaker, in particular the stabilising device and/or centring device, DE 10 2018 124 253 A1 is included or referred to—also with regard to the practicability and/or complete disclosure.

A sound panel of a conventional planar loudspeaker is always flat. The disadvantage of this is that the planar loudspeaker is therefore not suitable for installation in uneven spaces, e.g. curved vehicle headliners.

The invention therefore aims to create a loudspeaker which has the advantages of a planar loudspeaker and is at the same time suitable for installation in uneven spaces.

This task is solved by the devices having the features of the independent requirements.

The loudspeaker according to the invention comprises a sound panel and a mounting.

The sound panel can be designed as a flat membrane. For example, the loudspeaker may be a flat membrane loudspeaker.

Alternatively, the sound panel can also replace a membrane. For example, the sound panel can be designed rigidly. Preferably, the sound panel consists of a light material and/or a composite material. Preferably, the sound panel can be designed as a “carbon sandwich”. For example, a Rohacell® material can be combined with carbon, e.g. baked, with carbon.

The loudspeaker has a mounting. For example, the sound panel can be connected, preferably indirectly, to the mounting. For example, the sound panel can be attached to a vehicle headliner via the mounting.

A support frame for the sound panel is not necessary, but nevertheless conceivable.

The mounting can be designed as made up in one piece or in multiple pieces.

Preferably, the loudspeaker is designed as a planar loudspeaker.

The term planar loudspeaker is to be understood in a broad sense and also includes a sound panel that is not completely flat but bent and/or curved to a certain extent. However, this does not include speaker bodies that are completely curved to form a funnel or cone. Preferably, the loudspeaker does not have a speaker basket.

The loudspeaker has at least one drive unit for driving the sound panel. Preferably, the drive unit is attached to the mounting.

The drive unit is preferably designed to cause the sound panel to vibrate in order to generate sound. Preferably, the drive unit is designed as an electrodynamic drive. For example, a current-carrying conductor, e.g. a wire, can be held in a magnetic field. Thus a force is exerted on the sound panel connected to the drive unit.

The drive unit has a bobbin, preferably plate-shaped or ring-shaped, with a coil. The bobbin may, for example, consist solely of the coil. Alternatively, the bobbin may have, for example, a coil carrier on and/or in which the coil is formed. The coil carrier can be plate-shaped or ring-shaped, for example.

Furthermore, the drive unit has a magnet device.

For example, the bobbin may be arranged in a gap between two magnet units of the magnet device.

The voice coil can move between two bar magnets, e.g. neodymium magnets. The coil body is movable in a direction perpendicular to a straight line connecting the two magnet units, for example depending on the electromagnetic interaction between the coil and the magnet device. For example, the bobbin can move perpendicular to the sound panel.

Preferably, the bobbin moves in a piston-shaped manner.

For example, the coil is wound in such a way that it extends at least substantially along a plane oriented in parallel with a direction of movement.

Several, e.g. two, three, four, five, six or more, coil layers may be provided. The coil layers can, for example, be arranged in parallel to each other.

According to the invention, the sound panel has a bend and/or curvature.

The sound panel may be completely bent and/or curved. Alternatively, only at least a partial area of the sound panel may be bent and/or curved. For example, at least one peripheral region or two opposite or all peripheral regions of the sound panel can be straight and lie, for example, in one plane. In this case, for example, only the inner area of the sound panel can be bent and/or curved.

In this way, the sound panel is suitable for installation in uneven spaces.

The sound panel may be curved around at least one axis, e.g. the X- and/or Y-axis. Furthermore, the sound panel may be curved around two or three axes, e.g. the X-, Y- and/or Z-axis. For example, the sound panel can thus be bent and/or curved in three dimensions.

A face of the bobbin fixed to the sound panel is adapted to the shape of the bend and/or curvature.

In this manner, the bent and/or curved sound panel can be made to vibrate.

The bobbin can preferably be designed as a flat plate. The cross-section of the plate can, for example, form a straight line. The projection line of the bobbin onto the sound panel is preferably straight.

The ends of the bobbin are open, for example. Unlike in case of a cone loudspeaker, for example, the ends of the bobbin are not connected to each other and do not form a ring and/or cylinder. In the projection, the contact area between the bobbin and the sound panel thus forms a straight line.

Alternatively, the ends of the bobbin can also be closed, for example. In this case, the bobbin forms a ring or cylinder. In the projection, the contact area between the bobbin and the sound panel thus forms a circle.

Preferably, the loudspeaker according to the invention does not have a central dust cap, as provided for example in cone loudspeakers.

Preferably, the loudspeaker according to the invention is not axially symmetrical with respect to the centre axis of the drive unit.

Further developments of the invention can also be found in the dependent requirements, the description and the accompanying drawings.

According to one design, the sound panel has a circular arc-shaped cross-section with a centre angle between 0° and 270°, preferably between 40° and 70°.

This can apply to the X-direction and/or Y-direction. The centre angle in the X-direction and the centre angle in the Y-direction may be the same or different.

The curvature of the sound panel is approximately described by an extruded circular segment. The sound panel can have end points that do not touch and/or limit the circle segment.

According to a another design, the sound panel is convexly bent and/or curved.

In this way, the sound panel can be adapted to the shape of the object on and/or in which the loudspeaker is mounted.

According to another design, the sound panel is concavely bent and/or curved.

In this way, the sound panel can be adapted to the shape of the object on and/or in which the loudspeaker is mounted.

A combination of convex and concave bending and/or curvature is also possible. For example, the sound panel can be bent and/or curved convexly in the X-direction and concavely in the Y-direction, and vice versa.

According to another design, the bobbin is positively fixed, for example glued, to the sound panel.

Preferably, the complete end face of the bobbin is positively fixed to the sound panel.

For example, the front side of the bobbin can be bent convexly and/or concavely.

The vibrations are thus transmitted directly to the sound panel.

According to another design, at least or exactly two, three, four, five, six or more drive units are provided. For example, the sound panel is driven in parallel by two linear drives. The drives act in a planar manner, i.e. not in a point-like manner. In this way, for example, the formation of flexible shafts can be prevented.

Preferably, the drive units can be attached to the same mounting, although different mountings are also possible.

For example, a stabilising device can optionally be arranged between the drive units.

According to another design, at least one centring device is provided for centring the sound panel and/or at least part of the drive unit, preferably the plate-shaped bobbin. Preferably, a voice coil can be centred between bar magnets.

The centring device can preferably be arranged in a different plane as a stabilising device.

By arranging the stabilising device in a first plane and the centring device in a second plane, for example, only desired piston movements are possible and all other movements, e.g. tilting, horizontal displacement and/or axial twisting, are prevented.

The centring device has at least one lifting section which is movable, flexible and/or elastic.

For example, the modulus of elasticity may be less than 20 GPa, 15 GPa, 10 GPa, 5 GPa, 1 GPa or 0.1 GPa.

The lifting section can perform a lifting movement between 1 mm and 10 mm, preferably between 4 mm and 6 mm.

The smaller the area of the sound panel, the greater the lifting movement must be.

The centring device can be fixed to the sound panel and/or the holder, for example, by means of an adhesive. The lifting section dynamically fixes the sound panel to the mounting. The sound panel can thus, for example, only perform the desired piston movement.

The centring device can, for example, be identical in construction to the stabilising device Preferably, however, they are designed differently. For example, the stabilising device—in contrast to the centring device—can be designed as a pot spider.

Preferably, the stabilising device has a larger diameter than the centring device.

The centring device and the stabilising device can, for example, be arranged coaxially and/or concentrically to each other. Altogether, this results in a spider that is linearly effective in the lifting direction, so to speak. The centring device and the stabilising device can, for example, move in opposite directions relative to each other.

Alternatively, the centring device and the stabilising device can also be arranged at different locations and thus not one above the other. For example, a triangular arrangement of the centring device(s) and the stabilising device(s) is conceivable.

For example, the stabilising device can be movably connected to the sound panel, while the centring device can be movably attached to the mounting. The stabilising device and the centring device are thus each fixed on only one side.

The stabilising device can preferably have a stabilising mounting. This can, for example, be centrally connected to the lifting section. For example, the stabilising support can be designed rigidly, for example as a tube.

The stabilising mounting can be firmly attached to the mounting, e.g. glued. Thus, only the section of the stabilising device facing the sound panel is movable.

On the other hand, the centring device can preferably have a centring mounting. This can be centrally connected to the lifting section, for example. For example, the centring mounting can be designed rigidly, e.g. as a tube.

The centring mounting can be fixed to the sound panel, e.g. glued. Only the section of the centring device facing the mounting is movable.

Preferably, the diameter of the centring mounting is smaller than the diameter of the stabilising mounting. For example, the centring mounting can be arranged inside the stabilising mounting.

This arrangement in different planes stabilises the planar loudspeaker. For example, the sound panel and/or the drive unit is thereby guided, stabilised and/or centred. Nevertheless, a piston-like lifting movement is made possible.

According to another design, the centring device does not encase the drive unit.

According to another design, the centring device is spaced apart from the drive unit.

Consequently, the centring device does not touch the drive unit.

According to another design, an end face of the centring device fixed to the sound panel is adapted to the shape of the bend and/or curvature.

In this way, the bent and/or curved sound panel can be centred over a large area.

According to another design, the centring device is positively fixed to the sound panel.

Preferably, the entire front side of the centring device is positively fixed to the sound panel.

For example, the front side of the centring device can be bent convexly and/or concavely.

According to another design, the centring device is arranged centrally on the sound panel. For example, exactly one centring device can be provided.

According to another design, several centring devices are distributed over the sound panel and arranged, for example, at four corner areas of the sound panel.

The sound panel is thus evenly centred.

Optionally, a central centring device can also be provided.

According to another design, at least one stabilising device is provided for stabilising a movement of the sound panel.

A coil, e.g. magnetic field coil and/or voice coil, of the drive unit is automatically centred by the stabilising device, for example. An axial, vertical and/or horizontal rotation of the coil is thereby prevented. The upper and lower edges of the bobbin thus run parallel to the edges of the magnets, for example, during the entire movement sequence and thus in the magnetic field in the desired manner.

The stabilising device is arranged between the sound panel and the mounting and has at least one lifting section which is designed to be movable, flexible and/or elastic.

For example, the modulus of elasticity may be less than 20 GPa, 15 GPa, 10 GPa, 5 GPa, 1 GPa or 0.1 GPa.

The lifting section can perform a lifting movement between 1 mm and 10 mm, preferably between 4 mm and 6 mm.

The smaller the area of the sound panel, the greater the lifting movement must be, for example.

The stabilising device can be attached to the sound panel and/or the mounting, for example, by means of an adhesive. The sound panel is dynamically fixed to the mounting by the lifting section. The sound panel can thus, for example, only perform the desired piston movement.

According to another design, the stabilising device does not encase the drive unit.

According to another design, the stabilising device is spaced from the drive unit.

Consequently, the stabilising device does not come into contact with the drive unit.

According to another design, a front side of the stabilising device fixed to the sound panel is adapted to the shape of the bend and/or curvature.

In this way, the bent and/or curved sound panel can be stabilised over a large area.

According to another design, the stabilising device is positively fixed to the sound panel.

Preferably, the entire end face of the stabilising device is positively fixed to the sound panel.

For example, the front side of the stabilising device can be bent convexly and/or concavely.

According to another design, the stabilising device is arranged centrally on the sound panel. For example, exactly one stabilising device can be provided.

According to another design, several stabilising devices are distributed over the sound panel and arranged, for example, at four corner areas of the sound panel.

The sound panel is evenly supported, which increases stability.

Optionally, a central stabilising device can also be provided.

According to another design, the lifting section of the stabilising device and/or the centring device comprises or consists of a rubber, foam and/or fabric material.

By means of this elastic and/or flexible material, a lifting movement can be guided and/or limited. Alternatively, the lifting movement can be guided and/or limited, for example, by means of a spring device.

According to another design, the lifting section has a recess, for example a central recess. Alternatively, the lifting section can be closed and have a bottom and/or lid, for example.

The lifting section can be attached, e.g. glued, to the edge of the recess on the sound panel and/or the mounting.

According to another design, the lifting section is ring-shaped. For example, a recess of the lifting section can be ring-shaped.

The term ring-shaped is to be understood in a broad sense. Thus, in addition to circular ring-shaped shapes, oval shapes are also included. Alternatively, an angular design of the lifting section is conceivable.

According to another design, the lifting section comprises or consists of a bead and/or a spider.

A spider, which is also called a centring spider, can for example be designed as a radial and/or concentric spring element, for example a bidirectional disc spring.

For example, two oppositely oriented and interconnected spiders can be provided, which form the lifting section.

According to another design, the centring device and/or the stabilising device comprises at least one retaining ring. For example, a lifting section, preferably ring-shaped, can be attached to the retaining ring. Preferably, the lifting section is arranged coaxially and/or concentrically on the retaining ring.

The retaining ring may also be designed to be solid, for example in the form of a puck or a disc.

The lifting section, for example a bead, can for example be arranged between the retaining ring and the sound panel or between the retaining ring and the mounting.

According to another design, the centring device and/or the stabilising device comprises two retaining rings, which preferably have different diameters, the lifting section being arranged between the retaining rings.

For example, the retaining ring with a smaller diameter can be connected to the sound panel and the retaining ring with the larger diameter can be connected to the mounting. In this case, for example, less weight is applied to the sound panel. However, the opposite orientation is also conceivable. In this way, the retaining ring with the smaller diameter can be in contact with the mounting and the retaining ring with the larger diameter can be in contact with the sound panel.

Due to the different diameters, the retaining rings can be moved telescopically into each other, for example.

The lifting section connects the retaining rings to each other. For example, the lifting section can be glued to the retaining rings.

According to another design, at least one retaining element that does not completely surround the sound panel is provided on the sound panel.

For example, the holding element is designed to fix the sound panel to a support frame. In this way, for example, centring and/or stabilisation can be achieved. A centring device and/or stabilising device is not necessary, but nevertheless possible.

For example, the retaining element can be U-shaped. One leg of the retaining element may be connected, e.g. glued, to the sound panel, while the other leg may be connected, e.g. glued, to the support frame.

The sound panel may preferably have several, e.g. two, three, four, five, six, seven, eight or more, retaining elements. The retaining elements can, for example, be arranged on different, e.g. opposite, sides of the sound panel. Preferably, two retaining elements are arranged opposite each other. In this way, any lateral spring force is neutralised.

According to another design, a retaining element completely encasing the sound panel is provided on the sound panel.

For example, the retaining element is designed to fasten the sound panel to a mounting frame. In this way, for example, centring and/or stabilisation can be achieved. A centring device and/or stabilising device is not necessary, but nevertheless possible.

The sound panel is preferably fully connected and/or connectable to a support frame via the retaining element. Thus, for example, no air can escape between the sound panel and the support frame. Furthermore, no objects, for example dust particles, can penetrate. Preferably, there is a sealed, closed housing.

The sound panel can be rounded at the corners. In this case, the retaining element is also rounded at the corners. The radiuses at the corners can be made significantly smaller in relation to the size of the retaining element compared to conventional loudspeakers.

The retaining element, which is not fully circumferential and/or is fully circumferential, is preferably elastic. This allows, for example, a relative movement between the sound panel and the support frame.

For example, the modulus of elasticity may be less than 20 GPa, 15 GPa, 10 GPa, 5 GPa, 1 GPa or 0.1 GPa.

For example, the retaining element may comprise and/or consist of a plastic, rubber, foam, fabric, textile and/or paper material.

For example, the retaining element can be channel-shaped and/or run along the edge of the sound panel. Preferably, the retaining element is designed as a bead.

Preferably, the retaining element is fixed, e.g. glued, to the support frame as well as to the sound panel.

By means of the retaining element, a piston-like movement of the bobbin can be ensured.

The invention also relates to the use of a loudspeaker according to one of the preceding requirements for a vehicle headliner.

The vehicle may preferably be a motor vehicle, for example a passenger car, a motor home, a bus or a truck.

Finally, the invention relates to a loudspeaker, preferably a planar loudspeaker, comprising a, preferably flat, sound panel, a support frame in which the sound panel is arranged, and a mounting.

In addition, the loudspeaker has at least one drive unit, preferably attached to the holder, for driving the sound panel.

The loudspeaker comprises at least one stabilising device, preferably not encasing the drive unit and/or spaced from the drive unit, for stabilising a movement of the sound panel.

The stabilising device is arranged between the sound panel and the mounting and has at least one lifting section which is movable, flexible and/or elastic.

The sound panel is fully connected to the support frame via a movable, flexible and/or elastic retaining element.

An optional centring device may also be provided.

With regard to possible designs of the individual components, e.g. the sound panel, the drive unit, the stabilising device, the optional centring device, the lifting section and/or the retaining element, reference is made to the above explanations.

The sound panel can be designed to be flat or bent and/or curved.

All aspects, designs and features of the invention described in this document may be combined with each other, preferably independently of the specific design in which they are mentioned. Preferably, all objects of the dependent requirements can be combined with each other and with any object of the independent requirements.

The invention is described below by way of example with reference to the drawings. The figures show as follows:

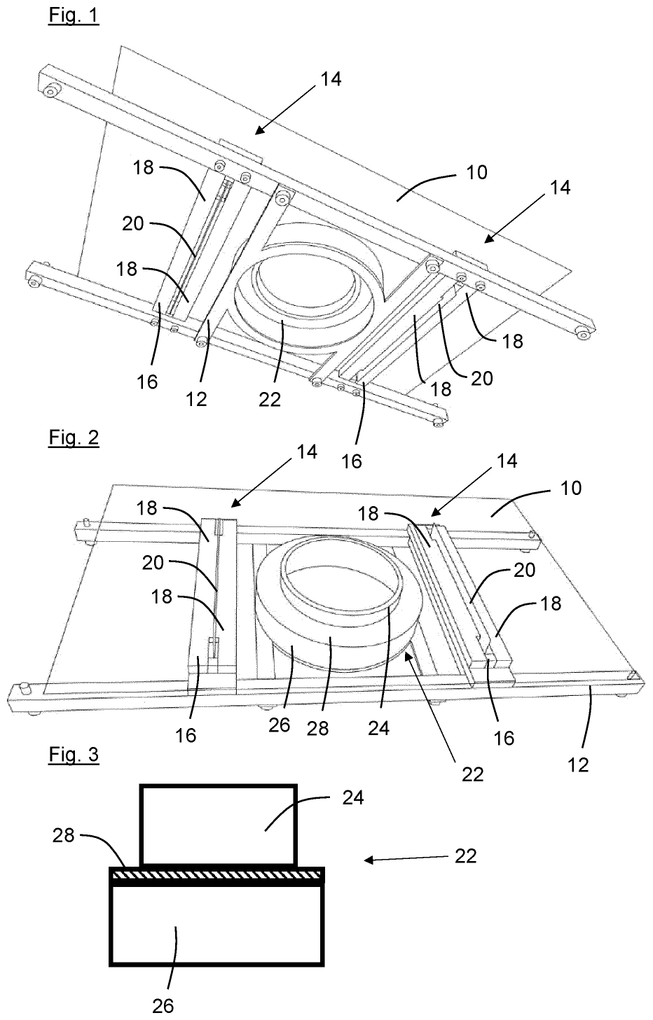

FIG. 1 a perspective bottom view of a design of a loudspeaker according to the invention,

FIG. 2 a top perspective view of a design of a loudspeaker according to the invention,

FIG. 3 a side view of a design of a stabilising device of a loudspeaker according to the invention,

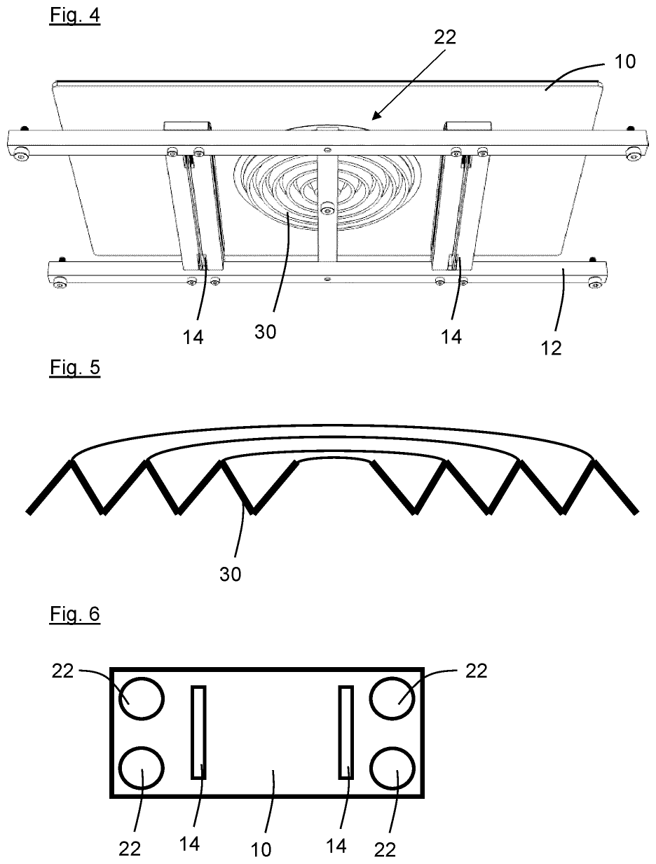

FIG. 4 a perspective bottom view of another design of a loudspeaker according to the invention,

FIG. 5 a sectional perspective view of a design of a stabilising device of a loudspeaker according to the invention,

FIG. 6 a top view of another design of a loudspeaker according to the invention,

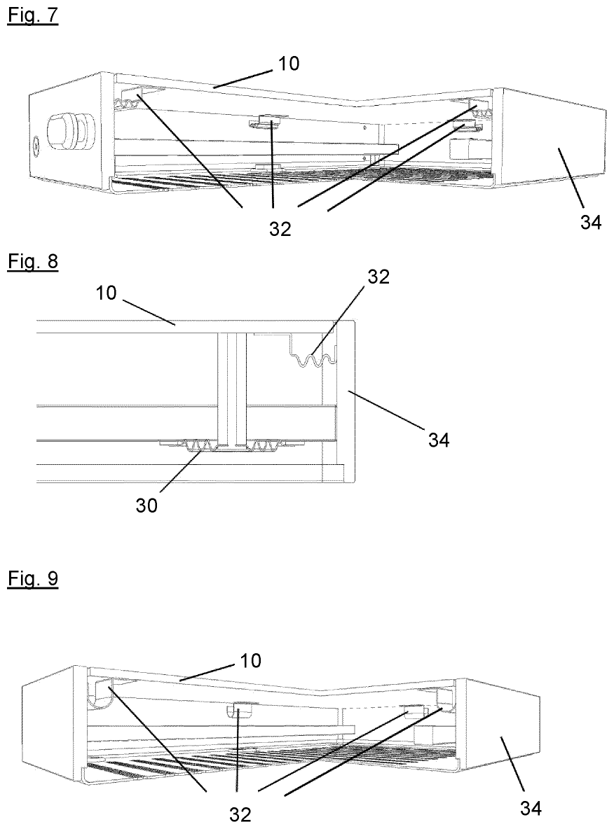

FIG. 7 a sectional perspective view of another design of a loudspeaker according to the invention,

FIG. 8 a sectional view of a design of a loudspeaker according to the invention,

FIG. 9 a sectional perspective view of another design of a loudspeaker according to the invention,

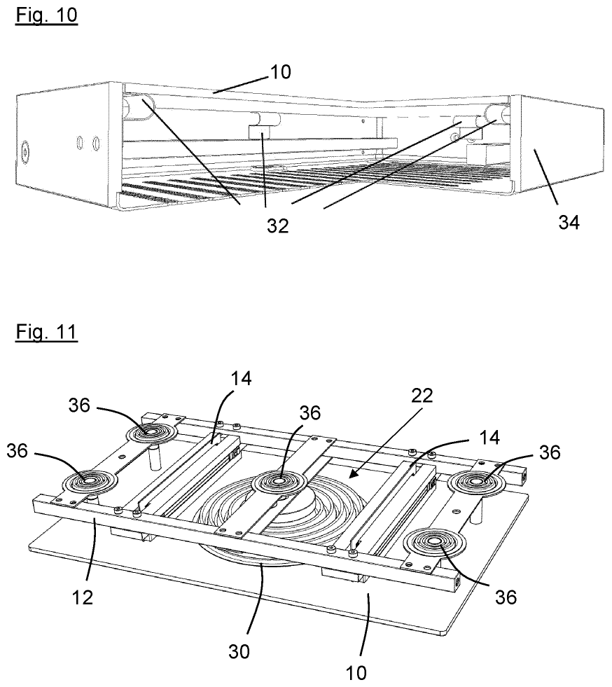

FIG. 10 a sectional perspective view of another design of a loudspeaker according to the invention,

FIG. 11 a perspective top view of another design of a loudspeaker according to the invention,

FIG. 12 a perspective top view of another design of a loudspeaker according to the invention,

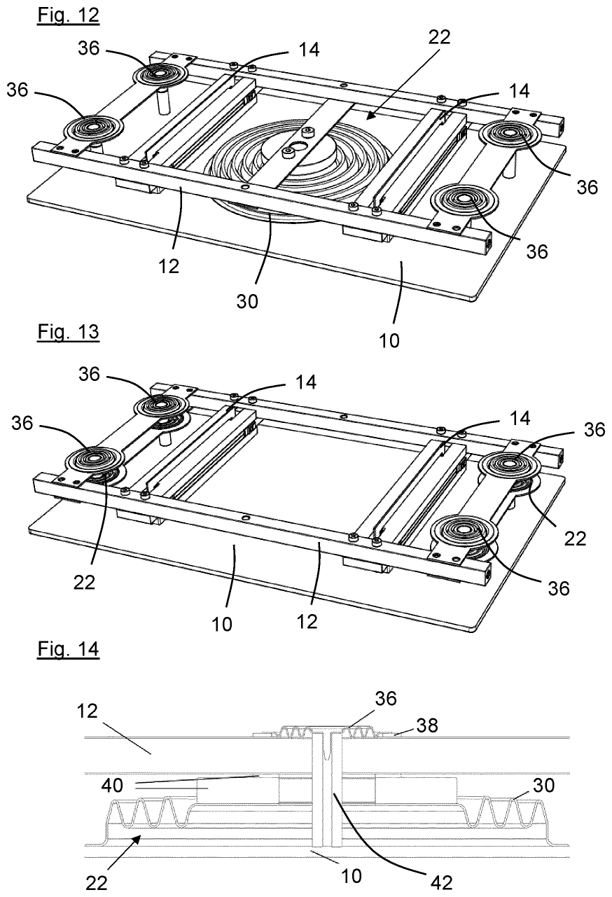

FIG. 13 a perspective top view of another design of a loudspeaker according to the invention,

FIG. 14 a sectional view of another design of a loudspeaker according to the invention, and

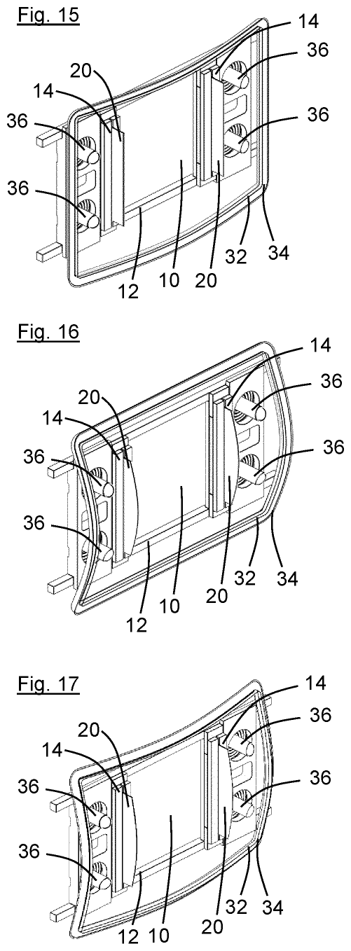

FIGS. 15 to 23 perspective views of further designs of a loudspeaker according to the invention.

First of all, it should be noted that the designs shown are of a purely exemplary nature. Individual features can therefore be realised not only in the combination shown, but also in a stand-alone configuration or in other technically sensible 25 combinations. For example, the features of one design may be combined with features of another design as desired. For example, the shape, number and/or position of the stabilising device(s), centring device(s) or drive units may vary.

The sound panel can be flat. Alternatively, the sound panel can be bent and/or curved.

The stabilising device(s) and/or centring device(s) shown can also be replaced by a retaining element that is fully circumferential.

If a figure contains a reference sign which is not explained in the directly associated descriptive text, reference is made to the corresponding preceding and/or subsequent explanations in the figure description. Thus, the same reference numbers are used for identical and/or comparable components in the figures and these are not explained again.

FIG. 1 shows a loudspeaker with a flat sound panel 10 and a mounting 12. The mounting 12 can have several individual parts connected to each other, for example screwed together. Alternatively, the mounting 12 may be a single piece.

Two drive units 14 are attached to the mounting 12, for example screwed together.

The drive units 14 each comprise a magnet device 16 with two magnet units 18 and a plate-shaped bobbin 20 arranged in a gap between them.

A stabilising device 22 is arranged between the drive units 14. The stabilising device 22 extends between the sound panel 10 and the mounting 12.

As can be seen in the top view shown in FIG. 2 (the sound panel 10 is depicted transparent), the stabilising device 22 comprises a first retaining ring 24 and a second retaining ring 26. The first retaining ring 24 has a smaller diameter than the second retaining ring 26.

As can also be seen in FIG. 3, a lifting section in the form of a bead 28 is provided between the retaining rings 24, 26. By means of the lifting section 28, the retaining rings 24, 26 are connected to each other so that they can move in relation to each other. The stabilising device 22 can thus simulate the movement of the sound panel 10, which is driven synchronously by the drive units 14, for example.

In FIG. 4, the stabilising device 22 is formed by a spider 30. Retaining rings are not necessary in this case.

According to the sectional view in FIG. 5, the spider 30 is designed as a kind of concentric spring. The spider 30 can, for example, have a central recess or be closed.

Two spiders 30 can also be used together. The spiders 30 can in this case be mounted in opposite directions or coaxially one above the other. The spring deflection is then extended.

In the design shown in FIG. 6, four stabilising devices 22 are provided instead of a central stabilising device. These are arranged at the corner areas of the sound panel

FIG. 7 shows a sound panel 10 that is connected to a support frame 34 via retaining elements 32.

The retaining elements 32 are comparatively narrow and do not extend over the entire circumference of the sound panel 10, although this is also possible. For example, the retaining elements 32 are narrower than the distance between two retaining elements 32.

The retaining elements 32 can, for example, be evenly distributed on the sound panel 10. Preferably, at least one retaining element 32 is provided on each side of the sound panel 10. In this way, the sound panel 10 can be stabilised and/or centred on each side.

The retaining elements 32 are preferably elastic. This allows, for example, a relative movement between the sound panel 10 and the support frame 34.

As can be seen in FIG. 8, the retaining element 32 may have an undulating section. This allows a certain amount of clearance.

One leg of the retaining element 32 may be connected to the sound panel 10, while the other leg may be connected to the support frame 34.

FIG. 9 shows that the retaining element 32 can also be designed in a U-shape. The legs of the U-shaped retaining element 23 can be oriented in parallel to the support frame 34, for example.

The holding element 23 can virtually bend during a lifting movement of the sound panel 10. The apex can, for example, increase and/or decrease.

As shown in FIG. 10, the legs of the U-shaped retaining element 23 may be oriented in parallel to the sound panel 10, for example.

The retaining element 23 can virtually unroll during a lifting movement of the sound panel 10.

FIG. 11 shows a loudspeaker with a central stabilising device 22 and multiple centring devices 36. The centring devices 36 are arranged above the stabilising device 22 and thus in a different plane.

A centring device 36 is arranged coaxially to the stabilising device 22.

This can also be omitted, as can be seen in FIG. 12. Due to the arrangement in different planes, sufficient stabilisation and/or centring is ensured even if the centring devices 36 and the stabilising device 22 are not arranged directly one above the other.

As shown in FIG. 13, multiple, for example decentralised, stabilising devices 22 can be provided. For example, a stabilising device 22 can be arranged in every corner area. A centring device 36 can be located directly above it, for example.

In FIG. 14, a centring device 36 is arranged coaxially above a stabilising device 22. The centring device 36 and the stabilising device 22 can, for example, move in opposite directions in relation to each other.

The stabilising device 22 is movably connected to the sound panel 10, while the centring device 36 can be movably attached to the mounting 12 via a retaining means 38.

The stabilising device 22 can preferably have a stabilising holder designed as a stabilising tube 40. The stabilising holder 40 is firmly attached, e.g. glued, to the mounting 12.

The centring device 36 has a centring holder designed as a centring tube 42. The centring tube 42 can be designed to be hollow or solid.

The centring holder 42 is attached firmly, e.g. glued, to the sound panel 10.

Preferably, the diameter of the centring holder 42 is smaller than the diameter of the stabilising holder 40. For example, the centring holder 42 is arranged inside the stabilising holder 40.

FIG. 15 shows a loudspeaker with a sound panel 10 that is convexly curved in the X-direction. For better visibility, the sound panel 10 is depicted transparent.

A circumferential retaining element 32 connects the sound panel 10 to the support frame 34.

The bobbin 20 is adapted to the shape of the sound panel 10.

FIG. 16 shows a loudspeaker with a sound panel 10 that is convexly curved in the Y-direction.

The bobbin 20 is adapted to the shape of the sound panel 10.

The sound panel 10 shown in FIG. 17 is convexly curved in the X- and Y-directions.

The bobbin 20 is adapted to the shape of the sound panel 10.

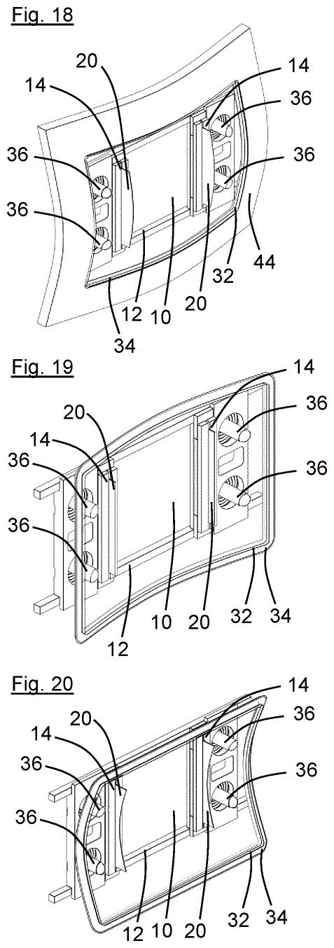

FIG. 18 shows a condition in which the speaker is installed in a vehicle headliner 44.

FIG. 19 shows a loudspeaker with a sound panel 10 that is concavely curved in the X-direction.

The bobbin 20 is adapted to the shape of the sound panel 10.

FIG. 20 shows a loudspeaker with a sound panel 10 that is curved concavely in the Y-direction.

The bobbin 20 is adapted to the shape of the sound panel 10.

The sound panel 10 shown in FIG. 21 is concavely curved in the X- and Y-directions.

The bobbin 20 is adapted to the shape of the sound panel 10.

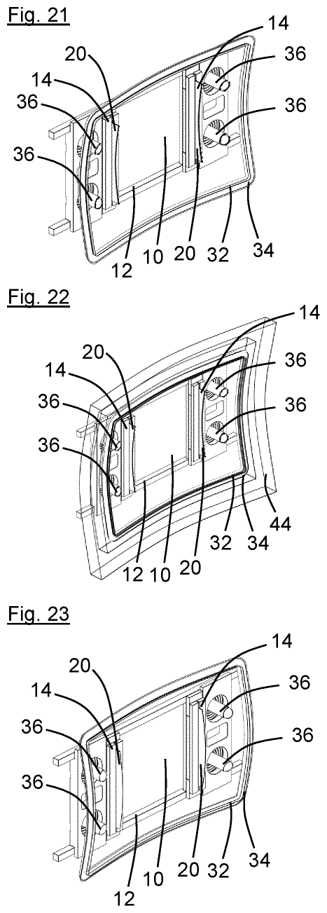

FIG. 22 shows a condition in which the speaker is installed in a vehicle headliner 44.

As shown in FIG. 23, the sound panel 10 may be curved convexly in the X-direction and curved concavely in the Y-direction. The reverse case is also conceivable.

### LIST OF REFERENCE NUMBERS

10 Sound panel
12 Mounting
14 Drive unit
16 Magnet device
18 Magnet unit
20 Bobbin
22 Stabilising device
24 first retaining ring
26 second retaining ring
28 Bead, lifting section
30 Spider
32 Retaining element
34 Support frame
36 Centring device
38 Retaining means
40 Stabilising tube, stabilising holder
42 Centring tube, centring holder
44 Vehicle headliner

1. Loudspeaker, comprising
a sound panel (10),
a mounting (12),
at least one drive unit (14), preferably attached to the mounting (12), for driving the sound panel (10), whereby
the drive unit (14) has a bobbin (20) with a coil and a magnet device (16), characterised in that
the sound panel (10) has a bend and/or curvature and an end face of the bobbin (20) fixed to the sound panel (10) is adapted to the shape of the bend and/or curvature.

2. (canceled)

3. (canceled)

4. (canceled)

5. (canceled)

6. Loudspeaker according to claim 1,
characterised in
that the sound panel (10) has a circular arc-shaped cross-section with a centre point angle between 0° and 270°, preferably between 40° and 70°.

7. Loudspeaker according to claim 1,
characterised in
that the sound panel (10) is bent and/or curved convexly.

8. Loudspeaker according to claim 1,
characterised in
that the sound panel (10) is bent and/or curved concavely.

9. Loudspeaker according to claim 1,
characterised in
in that the bobbin (20) is positively fixed to the sound panel (10).

10. Loudspeaker according to claim 1,
characterised in
that at least or exactly two drive units (14) are provided.

11. Loudspeaker according to claim 1,
characterised in
that at least one centring device (36) is provided for centring the sound panel and/or at least part of the drive unit (14), the centring device (36) having at least one lifting section (28) which is designed to be movable, flexible and/or elastic.

12. (canceled)

13. (canceled)

14. Loudspeaker according to claim 11,
characterised in
that an end face of the centring device (36) fixed to the sound panel (10) is adapted to the shape of the bend and/or curvature.

15. (canceled)

16. (canceled)

17. (canceled)

18. Loudspeaker according to claim 1,
characterised in
that at least one stabilising device (22) is provided for stabilising a movement of the sound panel (10), whereby the stabilising device (22) is arranged between the sound panel (10) and the mounting (12) and has at least one stroke section (28) which is designed to be movable, flexible and/or elastic.

19. (canceled)

20. (canceled)

21. Loudspeaker according to claim 18,
characterised in
that an end face of the stabilising device (22) fixed to the sound panel (10) is adapted to the shape of the bend and/or curvature.

22. (canceled)

23. (canceled)

24. (canceled)

25. (canceled)

26. (canceled)

27. (canceled)

28. (canceled)

29. (canceled)

30. (canceled)

31. (canceled)

32. Loudspeaker according to claim 1,
characterised in
that a retaining element (32) completely encasing the sound panel (20) is provided on the sound panel (20).

33. Use of a loudspeaker according to claim 1 for a vehicle headliner (44) of a vehicle.

34. Loudspeaker, preferably planar loudspeaker, comprising a, preferably flat, sound panel (10), a support frame (34) in which the sound panel (10) is arranged,
a mounting (12),
at least one drive unit (14), preferably fastened to the mounting (12), for driving the sound panel (10),
at least one stabilising device (22), preferably not surrounding the drive unit (14) and/or spaced from the drive unit (14), for stabilising a movement of the sound panel (10),
the stabilising device (22) being arranged between the sound panel (10) and the support frame (12) and having at least one lifting section (28), which is movable, flexible and/or elastic,
characterized in
that the sound panel (10) is circumferentially connected to the support frame (34) via a movable, flexible and/or elastic holding element (32).

35. Loudspeaker according to claim 1,
characterised in
that the loudspeaker is a planar loudspeaker.

36. Loudspeaker according to claim 1,
characterised in
that the bobbin (20) is plate-shaped, ring-shaped and/or arranged in a gap between two magnet units (18) of the magnet device (16).
